(19) United States
(12) Patent Application Publication
(10) Pub. No.: US 2006/0151235 A1
(43) Pub. Date: Jul. 13, 2006

(54) Steering device

(76) Inventor: Kazuo Chikaraishi, Gunma (JP)

Correspondence Address: MILES & STOCKBRIDGE PC, 1751 PINNACLE DRIVE, SUITE 500, MCLEAN, VA, 22102-3833, US

(21) Appl. No.: 10/546,638

(22) PCT Filed: Nov. 27, 2003
(86) PCT No.: PCT/JP03/15152

§ 371 Date: Aug. 24, 2005

(30) Foreign Application Priority Data
Mar. 26, 2003 (JP) 2003-84924

(51) Int. Cl. B62D 5/04; B62D 3/02

(52) U.S. Cl. 180/444; 280/93.513; 74/508

(57) ABSTRACT

A variable steering gear mechanism (9) is constructed of an external gear (15) connected to an input shaft (11), an internal gear (16) fixed to housing (10) and meshing with the external gear (15), an intermediate member (19) receiving a rotary force transmitted from the external gear (15), change means (18a, 31, 33a) capable of changing a rotation ratio of the output shaft (33) to a rotation of a guide member (18), and an Oldham coupling (17) connecting the intermediate member (19) to the guide member (18). When a speed reduction ratio thereof is set to, e.g., 6:1, it follows that the input member (18) of the change means makes a ¼ rotation (rotates through 90 degrees) during one-sided 1.5 rotations (540 degrees) of the input shaft (11), whereby a characteristic of the change means can be effectively utilized. A gear mechanism such as a hypocycloid mechanism has a characteristic capable of, though compact in configuration, obtaining a speed reduction ratio as large as 6:1, and also such a characteristic that the external gear (15), in addition to the self-rotation, revolves around the axis line of the internal gear (16), i.e., rotates while being eccentric. By contrast, according to the present invention, the use of the Oldham coupling (17) enables only the self-rotation to be extracted and transmitted by absorbing the eccentricity of the external gear (15). Additionally, a meshing length between the external gear (15) and the internal gear (16) becomes large, whereby smoother power transmission can be attained.

### TECHNICAL FIELD

The present invention relates to generally to a steering apparatus, more particularly to a steering apparatus capable of changing a steering gear ratio, and further to a vehicle power steering apparatus employing an electric motor.

### BACKGROUND ARTS

Known in the vehicle is a steering apparatus wherein a steering gear ratio (a steered angle of a tire with respect to a rotational angle of a steering wheel, which is also called a total gear ratio) is fixed. In the case of the steering apparatus having a 1-to-1 relationship between the rotational angle of the steering wheel and the steered angle of the tire, the steering gear ratio is set exclusively for ensuring high-speed stability of the vehicle. Namely, the steering gear ratio is set large in many cases so that the vehicle does not sensitively respond during high-speed traveling. When at such a steering gear ratio, however, the steering wheel is required to make a large number of rotations during low-speed traveling such as putting the vehicle in the garage, and the operation becomes complicated. For obviating such a problem, Japanese Patent No. 2826032 discloses a steering angle ratio variable mechanism capable of changing the steering gear ratio.

According to the steering angle ratio variable mechanism described in the aforementioned Patent document, the steering gear ratio can be made variable corresponding to a car speed etc., rectilinear stability is ensured in a way that restrains the steered angle of the traveling wheel with respect to the rotation of the steering wheel by increasing the steering gear ratio during, for example, the high-speed traveling, and the steering operation is prevented from getting complicated by increasing the steered angle of the traveling wheel with respect to the rotation of the steering wheel while decreasing the steering gear ratio during the low-speed traveling as when putting the vehicle into the garage.

Herein, in the steering angle ratio variable mechanism described in the Patent document given above, a groove extending in a radial direction is formed in a side end of an input shaft, a crank provided at a side end of an output shaft is inserted into the groove, and an axial line of the output shaft is shifted from an axis line of the input shaft, whereby a steering angle ratio can be changed. According to this construction, however, if the input shaft is within a rotational angle that is less than 180 degrees, a rotational angle of the output shaft can be increased and decreased on the basis of the rotational angle of the input shaft, corresponding to a shift quantity between the axis lie of the input shaft and the axis line of the output shaft. When the input shaft rotates through 180 degrees, however, the output shaft rotates invariably through 180 degrees due to a geometrical characteristic of the configuration described above, and the input shaft rotates through approximately 540 degrees (corresponding to 1.5 rotations of the steering wheel) on one side. This general type of steering apparatus has a problem that a degree of freedom for setting the steering angle ratio is restricted due to that characteristic.

### DISCLOSURE OF THE INVENTION

It is an object of the present invention to provide a steering apparatus capable of arbitrarily changing, though light in weight and compact in configuration, a characteristic of a steering angle with respect to a rotational angle of a steering wheel.

To accomplish the above object, a steering apparatus according to the present invention comprises housing, an input shaft connected to a steering wheel and supported rotatably along within the housing, an output shaft connected to a steering device and supported rotatably along within the housing, and a speed reducing mechanism connecting the input shaft to the output shaft, the speed reducing mechanism including a gear mechanism constructed of a first external gear connected to the input shaft and a first internal gear fixed to the housing and meshing with the first external gear, the first external gear making a self-rotation and a revolution about the first internal gear, change means having an input member inputting a rotary force from the first external gear and an output member outputting the rotary force to the output shaft, and capable of changing a rotational angle of the output member with respect to a rotational angle of the input member in accordance with a shift quantity between an axis line of the input member and an axis line of the output member, and an Oldham coupling so disposed as to be capable of transmitting power at least between the first external gear and the input member or between the output member and the output shaft.

The steering apparatus of the present invention is provided with the speed reducing mechanism including the gear mechanism (e.g., a hypocycloid mechanism) constructed of the first external gear connected to the input shaft and the first internal gear fixed to the housing and meshing with the first external gear, the first external gear making the self-rotation and the revolution about the first internal gear, the change means having the input member inputting the rotary force from the first external gear and the output member outputting the rotary force to the output shaft, and capable of changing the rotational angle of the output member with respect to the rotational angle of the input member in accordance with the shift quantity between the axis line of the input member and the axis line of the output member, and the Oldham coupling so disposed as to be capable of transmitting power at least between the first external gear and the input member or between the output member and the output shaft. Therefore, when a speed reduction ratio thereof is set to, e.g., 6:1, it follows that the input member of the change means makes a ¼ rotation (rotates through 90 degrees) during one-sided 1.5 rotations (540 degrees) of the input shaft, whereby a characteristic of the change means can be effectively utilized. The gear mechanism such as the hypocycloid mechanism has a characteristic capable of, though compact in configuration, obtaining a speed reduction ratio as large as 6:1, and also such a characteristic that the first external gear, in addition to the self-rotation, revolves around the axis line of the internal gear, i.e., rotates while being eccentric. By contrast, according to the present invention, the use of the Oldham coupling enables only the self-rotation to be extracted and transmitted by absorbing the eccentricity of the external gear. Additionally, a meshing length between the external gear and the internal gear becomes large, whereby smoother power transmission can be attained.

Further, it is preferable that a first Oldham coupling is disposed between the first external gear and the input member, and a second Oldham coupling is disposed between the output member and the output shaft.

Moreover, it is preferable that a speed increasing mechanism is provided between the second Oldham coupling and the output shaft, and the speed increasing mechanism has a gear mechanism constructed of a second internal gear fixed to the housing and a second external gear connected to the second Oldham coupling and to the output shaft and meshing with the second internal gear, the second external gear making the self-rotation and the revolution about the second internal gear. When the speed reduction ratio is set to 6:1 by the speed reducing mechanism, if the decelerated rotation is transmitted as it is to the output shaft and if the steering device includes a rack-and-pinion mechanism, a pinion diameter of the pinion connected to the output shaft is required to considerably increase in order to obtain a sufficient steered angle of the traveling wheel, however, it is generally difficult to install such a large pinion into a narrow engine room. By contrast, according to the present invention, the pinion diameter can be made small as in the case of the conventional pinion by providing the speed increasing mechanism that acquires a large speed reduction ratio in a compact configuration. Namely, the present invention exhibits an advantage that a space between the input shaft and the output shaft in the conventional steering apparatus can accommodate the aforementioned mechanism without largely changing an existing engine room layout.

In the case of an electric motor assist, it is preferable that a steering assist torque sensor is disposed closer to a steering wheel than the change means. The change means fluctuates torque to be transmitted corresponding to the shift quantity between the axis line of the input member and the axis line of the output member. In this case, the steering assist torque sensor is disposed closer to the steering wheel than the change means, whereby the torque fluctuation can be absorbed. It should be noted that the steering assist includes both of hydraulic assist and electric motor assist. In the case of the electric motor assist, an auxiliary steering force of the electric motor may be outputted to the input shaft and may also be outputted to the output shaft and may further be outputted to the rack shaft of the rack-and-pinion mechanism.

### BRIEF DESCRIPTION OF THE DRAWINGS

FIG. 1 is a sectional view of a variable steering gear ratio mechanism that can be built in a steering apparatus according to the present embodiment (a first embodiment);

FIG. 2 is a sectional view of the configuration cut off along the line II-II in FIG. 1 as viewed in an arrow direction;

FIG. 3 is an exploded perspective view of an Oldham coupling;

FIGS. 4A and 4B are views of a guide plate and a large-diameter disc portion as viewed in an axis-line direction;

FIG. 5 is a graphic chart showing one example of a characteristic of a steering angle with respect to a rotational angle of a steering wheel in the case of changing an offset quantity Δ;

FIG. 6 is a sectional view of the steering apparatus having a built-in variable steering gear ratio mechanism;

FIG. 7 is a sectional view of a variable steering gear ratio mechanism according to a second embodiment;

FIG. 8 is a sectional view of the steering apparatus having the built-in variable steering gear ratio mechanism according to the second embodiment; and

FIG. 9 is a sectional view of the steering apparatus having a built-in variable steering gear ratio mechanism according to a third embodiment.

### BEST MODE FOR CARRYING OUT THE INVENTION

An embodiment of the present invention will hereinafter be described with reference to the drawings.

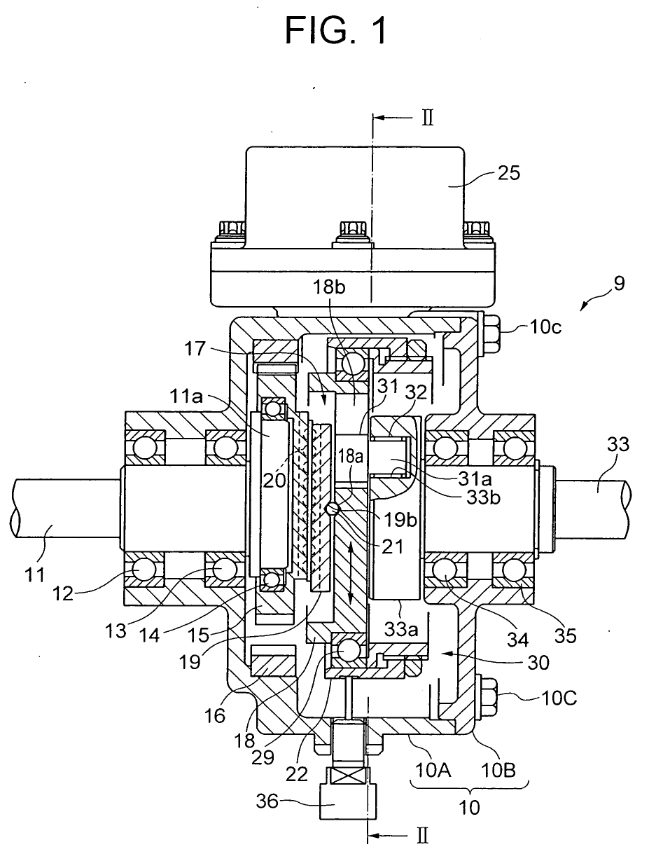

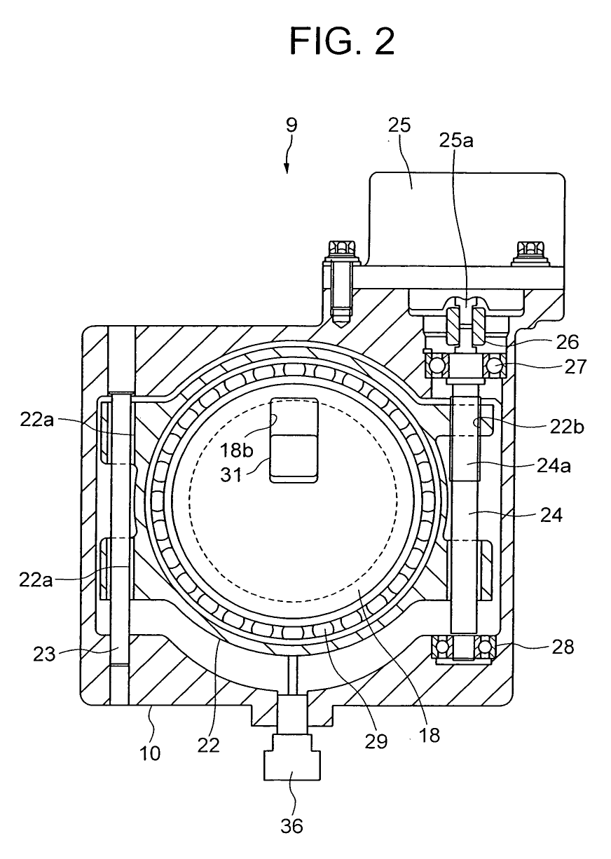

FIG. 1 is a sectional view of a variable steering gear ratio mechanism (power transmission mechanism) 9 that can be built in a steering apparatus according to the first embodiment. FIG. 2 is a sectional view of the configuration cut off along the line II-II in FIG. 1 as viewed in an arrow direction. Housing 10 is constructed of a housing body 10A and a cover member 10B fixed to the housing body 10A by a bolt 10C. In FIG. 1, an input shaft 11 connected to an unillustrated steering shaft is so supported by bearings 12, 13 as to be rotatable along within the housing body 10A. A large-diameter disc portion 11a is formed in a way that deviates an axis line at a right side end of the input shaft 11 in FIG. 1. The large-diameter disc portion 11a rotatably supports an external gear (first external gear) 15 through a bearing 14.

The external gear 15 meshes with an internal gear (first internal gear) 16 fixed to the housing 10. The external gear 15 and the internal gear 16 configure a hypocycloid speed reducing mechanism. The external gear 15 is connected via an Oldham coupling 17 to a guide plate 18.

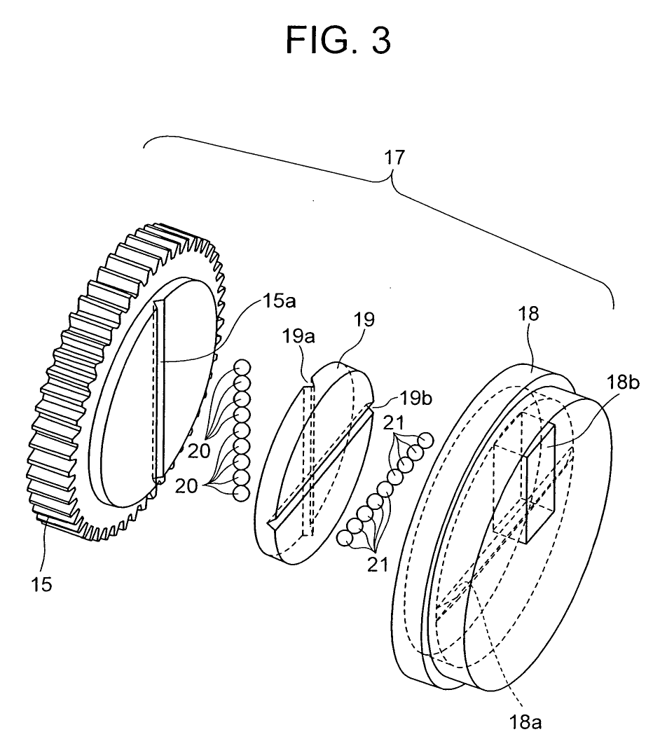

FIG. 3 is an exploded perspective view of the Oldham coupling 17. A plurality of balls 20 are so disposed as to be rollable between a raceway 15a formed in the surface of the external gear 15 and a raceway 19a formed in an opposite surface (defined as an undersurface) of a disc-shaped intermediate member 19. On the other hand, a plurality of balls 21 are so disposed as to be rollable between a raceway 19b formed orthogonally to the raceway 19a in the surface of the intermediate member 19 and a raceway 18a formed in an opposite surface of the guide plate 18. Note that an illustration of a ball holder is omitted throughout the drawings. The Oldham coupling 17 is capable of transmitting a rotary force even when the axis line of the guide plate 18 deviates from the axis line of the external gear 15.

Referring to FIGS. 1 and 2, a movable case 22 taking substantially a short cylindrical shape is disposed within the housing 10. The movable case 22 penetrates holes 22a formed in ear pieces on the left side in FIG. 2, and is movable in vertical directions in FIG. 2 along a shaft fixed to the housing 10. Further, the movable case 22 is driven by a driving shaft 24 having a screw portion 24a screwed into a screw hole formed in an ear piece on the right side in FIG. 2. One side end (an upper end in FIG. 2) of the driving shaft 24 is connected via a coupling 26 to a rotary shaft 25a of a motor 25 fixed to the housing 10, and is so supported by a bearing 27 as to be rotatable along within the housing 10. The other side end (a lower end in FIG. 2) of the driving shaft 24 is supported by a bearing 28 so as to be rotatable along within the housing 10.

The movable case 22, as shown in FIGS. 1 and 2, rotatably supports the cylindrical guide plate 18 via a bearing 29. Note that the bearing 29 is given a preload from a preload applying mechanism 30 illustrated in FIG. 1, thereby preventing a backlash in the axis-line direction.

The guide plate 18 is, in an off-center position as shown in FIG. 2, formed with a rectangular guide hole 18b elongating in a radial direction in section. A square rod portion 31b of a slide member 31 engages with this guide hole 18b, thus becoming slidable along the guide hole 18b. The slide member 31 is constructed of a cylindrical portion 31a and the square rod portion 31b, and the cylindrical portion 31a is so supported by a needle bearing 32 as to be rotatable along within to a hole 33b formed in a large-diameter disc portion 33a of an output shaft 33. It should be noted that the guide plate 18 serving as an input member, the slide member 31 and the large-diameter cylindrical (disc) portion 33a serving as an output member (integral with the output shaft in this case), configure a change means.

The output shaft 33 formed with a pinion (unillustrated) meshing with an unillustrated rack shaft is supported by bearings 34 and 35 so as to be rotatable along within the housing 10. Note that the housing 10 is fitted with a sensor (which may be a potentiometer, etc.) 36 for detecting a moving quantity of the movable case 22.

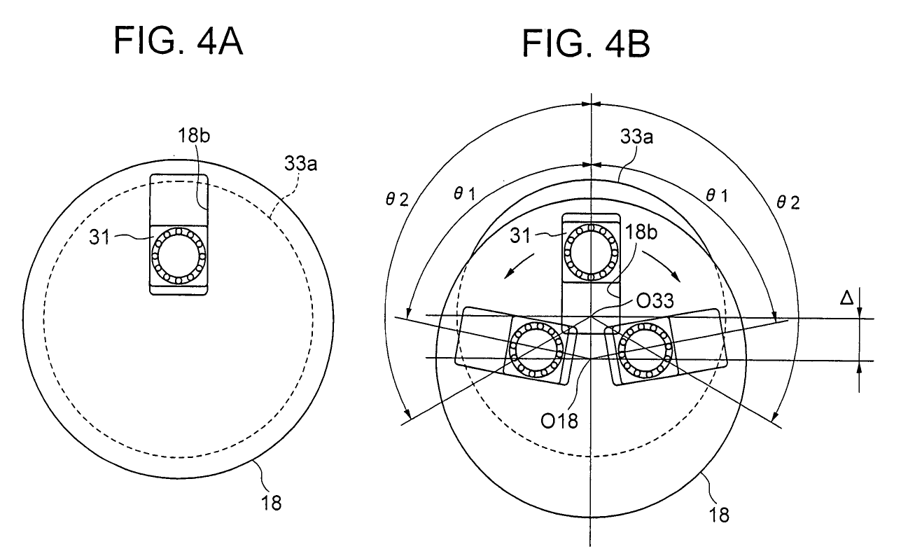

Next, an operation of the first embodiment will be explained. FIGS. 4A and 4B are views of the guide plate 18 and the large-diameter disc portion 33a as viewed in the axis-line direction. In FIG. 1, when the rotary force is applied to an unillustrated steering wheel, the rotary force is transmitted to the guide plate 18 via the Oldham coupling 17 from the input shaft 11. Herein, if the axis line of the guide plate 18 is coincident with the axis line of the large-diameter disc portion 33a (this is a state illustrated in FIG. 4A), the slide member 31 is not movable along the guide hole 18b, and the rotation of the guide plate 18 is transmitted directly to the large-diameter disc portion 33a, i.e., to the output shaft 33.

By contrast, in FIG. 2, the guide plate 18 is moved with respect to the large-diameter disc portion 33a by driving the motor 25, whereby an axis line 018 of the guide plate 18 and an axis line 033 of the large-diameter disc portion 33a, it is assumed, get offset (shift) with an offset quantity A as shown in FIG. 4B. In such a case also, the Oldham coupling 17 allows the transmission of the rotary force from the external gear 15 to the guide plate 18. The balls 20 reduce friction caused when sliding in the radial direction between the external gear 15 and a crossbar 19, while the balls 21 reduce friction caused when sliding in the radial direction between the crossbar 19 and the large-diameter cylindrical portion 33a.

Supposing that the guide plate 18 rotates just through an angle θ1 by dint of the rotary force given from the input shaft 1 at this time, as shown in FIG. 4B, the slide member 31 slides along the guide hole 18b, and the large-diameter disc portion 33a is thereby rotated through an angle θ2, wherein a relationship such as θ1>θ2 is established in this case. Accordingly, a rotational angle ratio becomes θ2/θ1 in accordance with the offset quantity Δ. Thus, even during traveling, the offset quantity Δ (detectable by the sensor 36) between the axis line O18 of the guide plate 18 and the axis line O33 of the large-diameter disc portion 33a can be set to an arbitrary value, and hence a characteristic of a steering angle with respect to a rotational angle of the steering wheel can be arbitrarily changed. It should be noted that the steering angle with respect to the rotational angle of the steering wheel is, it is preferable, determined to gain an optimum characteristic on the basis of a variety of parameters such as a car speed, a steering force, a steering angle and a steering speed.

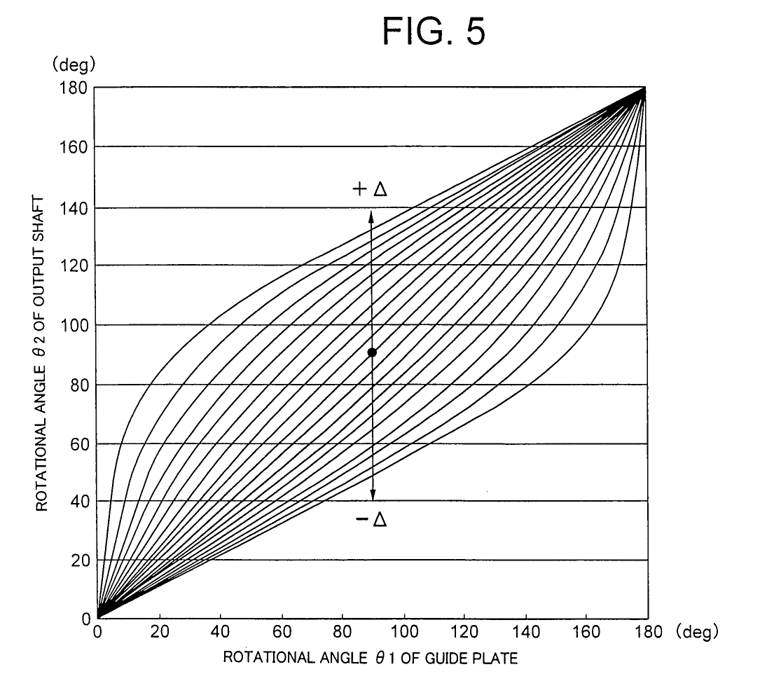

FIG. 5 is a graphic chart showing one example of the characteristic of the steering angle with respect to the rotational angle of the steering wheel in the case of changing the offset quantity Δ. As shown in FIG. 5, an output rotation of the output shaft 33 can be either advanced or delayed with respect to the input rotation of the guide plate 18 by changing offset quantity Δ.

Though obvious from FIG. 5, however, θ1=θ2 is established in any characteristics in a position to which the guide plate 18 rotates through 180 degrees, wherein the steering gear ratio can not be made variable. On the other hand, the steering wheel, i.e., the output shaft 33 generally makes approximately ±1.5 rotations (rotates through 540 degrees). Such being the case, according to the first embodiment, a speeding reducing mechanism having a speed reduction ratio (on the order of 6.0) as large as reducing, for instance, 540 degrees down to 90 degrees, is provided between the output shaft 33 and the guide plate 18, whereby the steering angle characteristic can be arbitrarily set.

Therefore, the first embodiment involves providing the hypocycloid speed reducing mechanism. More specifically, in FIG. 1, when the input shaft 11 rotates, the large-diameter disc portion 11a getting eccentric also rotates. Herein, the external gear 15 meshing with the internal gear 16, as the large-diameter disc portion 11a rotates, makes a slow self-rotation while revolving around the periphery of the axis line of the input shaft 11. The Oldham coupling 17 does not transmit the revolution of the external gear 15 but transmits only the self-rotation thereof. Herein, let Z2 be the number of teeth of the internal gear 16 and Z1 be the number of teeth of the external gear 15, a transmission gear ratio is given by (Z2−Z1)/Z1, wherein a speed reduction ratio “6.4” can be obtained by setting such as Z1=45 and Z2=52, and the large speed reduction ratio can, though compact, be actualized. Further, this hypocycloid speed reducing mechanism exhibits an advantage that a gear meshing length becomes large, and the operation gets smooth.

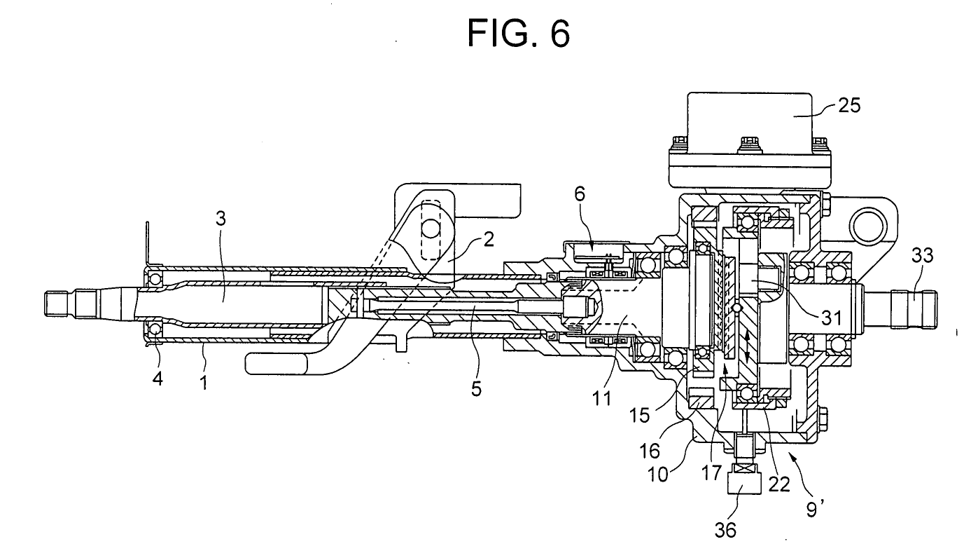

FIG. 6 is a sectional view of the steering apparatus having a built-in variable steering gear ratio mechanism 9′. The variable steering gear ratio mechanism 9′ illustrated in FIG. 6 has components that are slightly different in shape from those in the construction shown in FIG. 1, however, the functions of these components are the same. Hence, the main components having the same functions are marked with the same numerals and symbols, and their explanations are omitted.

In FIG. 6, the housing for the variable steering gear ratio mechanism 9′ is connected to a hollowed cylindrical column tube 1 slidably fitted via a bracket 2 to an unillustrated car body. A steering shaft 3 extending in the column tube 1 is so supported by a bearing 4 as to be rotatable along within the column tube 1. A portion on the side of the right side end, as viewed in FIG. 6, of the steering shaft 3 constructed of two pieces of parts in the same telescopic system as in the case of the column tube 1 in order to absorb energy caused when a collision occurs, takes a bottomed sac-hole-like shape, and a torsion bar 5 connects the bottom portion of the sac hole to a side end of the input shaft 11 of the variable steering gear ratio mechanism 9′. A steering assist torque sensor 6 for detecting the steering force applied to the steering wheel in a way that detects a quantity of torsion of the torsion bar 5, is provided on the side of the left side end, as viewed in FIG. 6, of the housing 10. A construction of the torque sensor 6 is described in, e.g., Japanese Patent No. 3329294 and so forth, and hence the details thereof are not hereinafter described.

In the steering apparatus in the first embodiment, the torque sensor 6 detects the steering force, corresponding to the steering force applied to the unillustrated steering wheel, and, for example, an unillustrated motor provided on the periphery of a rack shaft outputs a proper auxiliary steering force to the rack shaft. Further, the conventional rack shaft and the conventional steering apparatus can be diverted (to those in the first embodiment), and therefore costs can be restrained. By the way, according to the variable steering gear ratio mechanism shown in FIG. 1, the speed reduction ratio as large as, e.g., “6” or thereabouts can be taken, however, if the power is transmitted to the output shaft 33 at such a speed reduction ratio, for instance, a pinion diameter of a rack-and-pinion mechanism must be increased, and a degree of freedom is restricted in terms of layout. An embodiment that follows enables the pinion having the same diameter as hitherto taken to be used by providing a speed increasing mechanism.

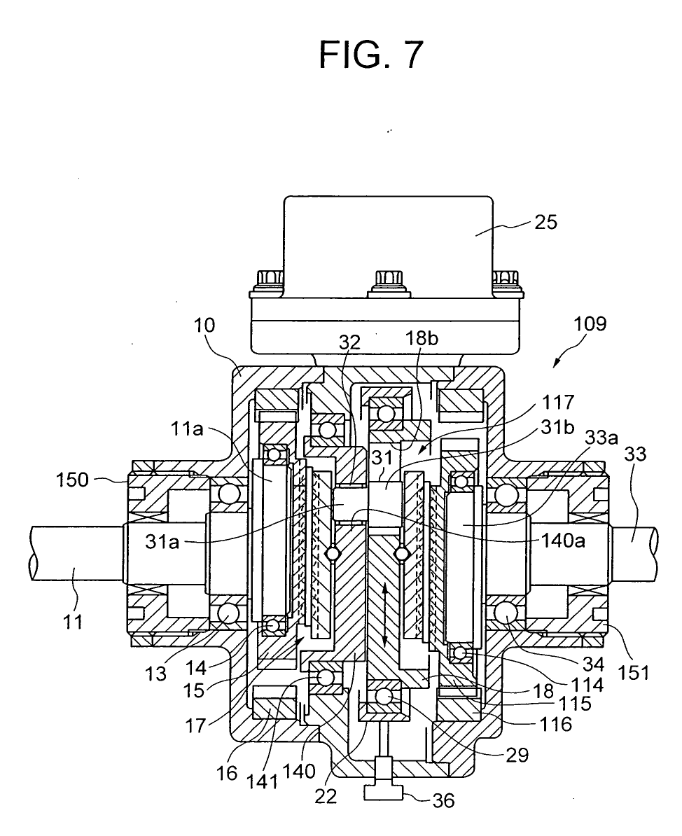

FIG. 7 is a sectional view of a variable steering gear ratio mechanism according to a second embodiment. A variable steering gear ratio mechanism 109 shown in FIG. 7 is different from the construction illustrated in FIG. 1 in terms of providing the speed increasing mechanism, so that the components exhibiting the common functions are marked with the same numerals and symbols, wherein the discussion will be focused mainly on the different points.

The large-diameter disc portion 11a formed in a way that deviates an axis line at a right side end of the input shaft 11 in FIG. 7, rotatably supports the external gear 15 through the bearing 14. The external gear 15 meshes with the internal gear 16 fixed to the housing 10. The external gear 15 and the internal gear 16 configure the hypocycloid speed reducing mechanism. The external gear 15 is connected via the Oldham coupling (first Oldham coupling) 17 to an intermediate member 140 so supported by a bearing 141 as to be rotatable along within the housing 10.

The intermediate member 140 is, in an off-center position as shown in FIG. 7, formed with a hole 140a into which the cylindrical portion 31a of the slide member 31 is rotatably fitted via the bearing 32. The movable case 22 taking substantially a short cylindrical shape is disposed adjacently to the intermediate member 140 in the housing 10. The movable case 22 has the same construction as that illustrated in FIG. 2 and is movable in the vertical directions as viewed in FIG. 7 by receiving the driving force of the motor 25. Inwardly of the movable case 22, the guide member 18 is so supported via the bearing 29 as to be rotatable along within the movable case 22.

The guide member 18 is formed with a rectangular guide hole 18b elongating in a radial direction in section. The square rod portion 31b of the slide member 31 engages with this guide hole 18b, thus becoming slidable along the guide hole 18b. Further, the guide member 18 is connected to an external gear (second external gear) 115 through an Oldham coupling (second Oldham coupling) 117 having the same construction as that shown in FIG. 3. The external gear 115 is so supported by a bearing 114 as to be rotatable about the large-diameter disc portion 33a (shifted from the axis line of the output shaft 33) formed at the side end portion of the output shaft 33, and meshes with an internal gear (second internal gear) 116 fixed to the housing 10. The external gear 115 and the internal gear 116 configure a hypocycloid speed increasing mechanism. Such a hypocycloid speed increasing mechanism having a reversed relationship between the input and the output with respect to the aforementioned hypocycloid speed reducing mechanism. Note that seal units 150, 151 for restraining foreign matters from entering, are attached between the housing 10 and the input shaft 11 and between the housing 10 and the output shaft 33. In the second embodiment, the intermediate member 140 serving as an input member, the slide member 31 and the guide plate 18 serving as an output member configure a change means.

In the second embodiment also, the offset quantity Δ between the axis line of the guide plate 18 and the axis line of the intermediate member 140 (which is herein coincident with the axis lines of the input shaft 11 and of the output shaft 33) can be set to an arbitrary value by driving the motor 25, and hence the characteristic of the steering angle with respect to the rotational angle of the steering wheel can be arbitrarily changed. Further, in the second embodiment, the speed reduction ratio of the hypocycloid speed reducing mechanism constructed of the external gear 15 and the internal gear 16 is set to approximately 6.0, and the speed increasing ratio of the hypocycloid speed increasing mechanism constructed of the external gear 115 and the internal gear 116 is set to approximately 6. In this case, the output shaft can make one rotation that is more or less by ±20% than one rotation of the input shaft when changing a rotational angle ratio between the intermediate member 140 and the guide plate 18 at ±20%, and namely, there being no necessity of increasing the pinion diameter of the conventional rack-and-pinion mechanism, it is possible to apply to the existing vehicle steering apparatus.

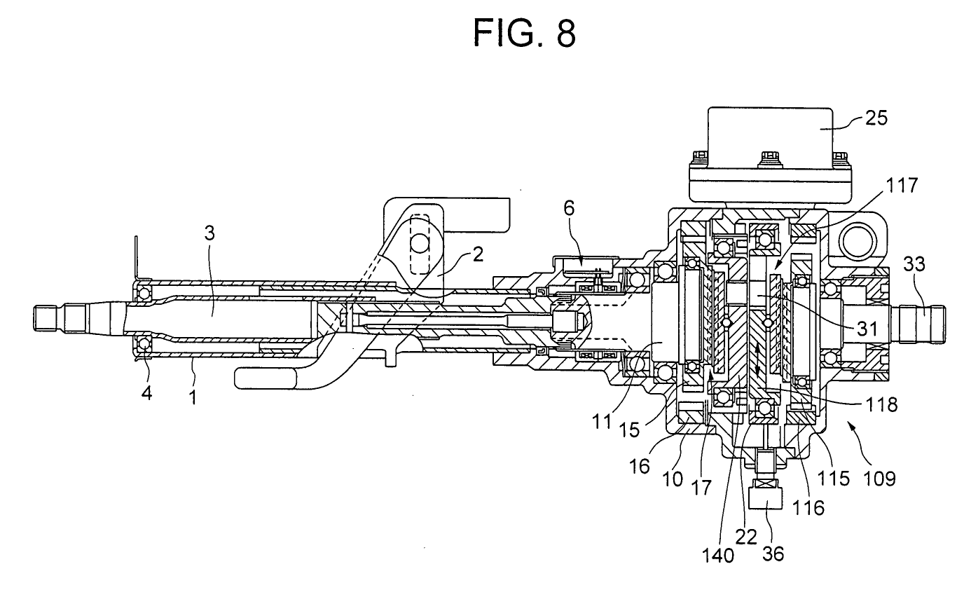

FIG. 8 is a sectional view of the steering apparatus having the built-in variable steering gear ratio mechanism 109. The variable steering gear ratio mechanism 109 shown in FIG. 8 has components that are slightly different in shape from those in the construction shown in FIG. 8, however, the functions of these components are the same. The configurations other than these different components are the same as those shown in FIG. 6, and their explanations are omitted hereinafter.

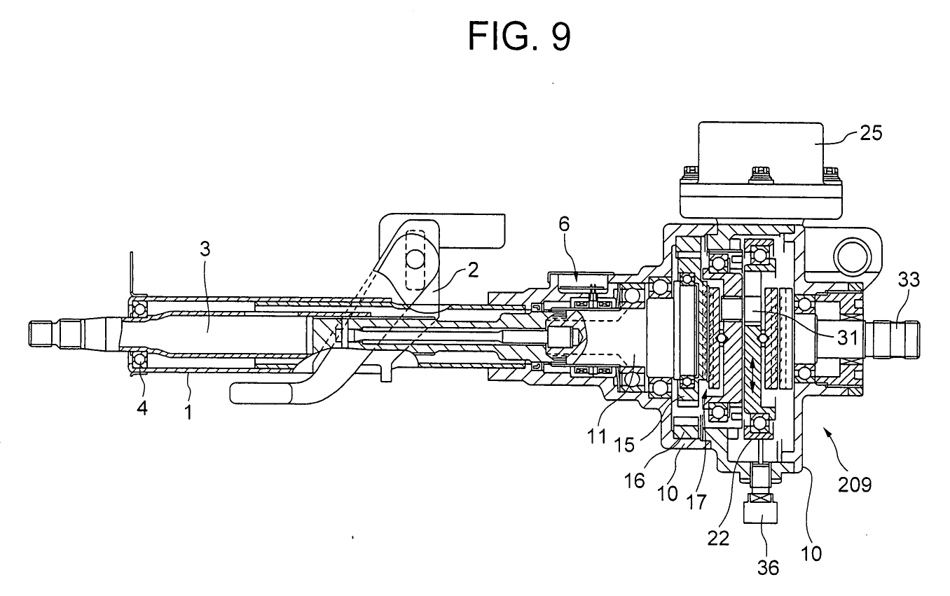

FIG. 9 is a sectional view of the steering apparatus having a built-in variable steering gear ratio mechanism 209 according to a third embodiment. The variable steering gear ratio mechanism 209 in the third embodiment is different from the variable steering gear ratio mechanism 109 shown in FIG. 8 in terms of only such a point that the speed increasing mechanism is omitted, and the guide member 18 is connected directly to the large-diameter disc portion 33a of the output shaft 33 via an Oldham coupling 117, and the operation of this mechanism 209 is the same as the construction shown in FIG. 6 exhibits, and therefore the explanation is omitted.

The present invention has been described in detail so far by referring to the embodiments but should not be construed as limited to the embodiments discussed above, and can be, as a matter of course, properly modified and improved within the scope that does not distort the gist of the invention.

1. A steering apparatus comprising:
housing;
an input shaft connected to a steering wheel and supported rotatably along within said housing;
an output shaft connected to a steering device and supported rotatably along within said housing; and
a speed reducing mechanism connecting said input shaft to said output shaft,
said speed reducing mechanism including:
a gear mechanism constructed of a first external gear connected to said input shaft and a first internal gear fixed to said housing and meshing with said first external gear, said first external gear making a self-rotation and a revolution about said first internal gear;
change means having an input member inputting a rotary force from said first external gear and an output member outputting the rotary force to said output shaft, and capable of changing a rotational angle of said output member with respect to a rotational angle of said input member in accordance with a shift quantity between an axis line of said input member and an axis line of said output member; and
an Oldham coupling so disposed as to be capable of transmitting power at least between said first external gear and said input member or between said output member and said output shaft.

2. A steering apparatus according to claim 1, wherein a first Oldham coupling is disposed between said first external gear and said input member, and a second Oldham coupling is disposed between said output member and said output shaft.

3. A steering apparatus according to claim 2, wherein a speed increasing mechanism is provided between said second Oldham coupling and said output shaft, and
said speed increasing mechanism has a gear mechanism constructed of a second internal gear fixed to said housing and a second external gear connected to said second Oldham coupling and to said output shaft and meshing with said second internal gear, said second external gear making the self-rotation and the revolution about said second internal gear.

4. A steering apparatus according to claim 1, wherein a steering assist torque sensor is disposed closer to a steering wheel than said change means.

5. A steering apparatus according to claim 2, wherein a steering assist torque sensor is disposed closer to a steering wheel than said change means.

6. A steering apparatus according to claim 3, wherein a steering assist torque sensor is disposed closer to a steering wheel than said change means.
